(19) United States
(12) Patent Application Publication
(10) Pub. No.: US 2014/0090730 A1
(43) Pub. Date: Apr. 3, 2014

(54) DEVICE FOR SEPARATING A FLUID MASS FLOW

(71) Applicant: AREVA GMBH, ERLANGEN (DE)

(72) Inventors: ROBERT BUETTNER, GROSSENSEEBACH (DE); GUENTHER SCHULZE, SEUKENDORF (DE); RALF WALTERSKOETTER, GERHARDSHOFEN (DE)

(73) Assignee: AREVA GMBH, ERLANGEN (DE)

(21) Appl. No.: 14/099,172

(22) Filed: Dec. 6, 2013

Related U.S. Application Data
(63) Continuation of application No. PCT/EP2012/072510, filed on Nov. 13, 2012.

(30) Foreign Application Priority Data
Jan. 26, 2012 (DE) 102012201129.3

(51) Int. Cl. F16L 41/02

(52) U.S. Cl. CPC F16L 41/02
USPC 137/561 A

(57) ABSTRACT

A device separates a fluid mass flow in a nuclear plant. The device contains a primary end piece for conducting the fluid mass flow and a plurality of secondary end pieces for conducting a plurality of separate partial flows of the fluid mass flow. A number of separating elements is provided in the area within the primary end piece, and each of the partial areas defined by the separating element or the separating elements opens in a secondary end piece clearly assigned to the partial area.

### CROSS-REFERENCE TO RELATED APPLICATION

This is a continuation application, under 35 U.S.C. §120, of copending international application No. PCT/EP2012/072510, filed Nov. 13, 2012, which designated the United States; this application also claims the priority, under 35 U.S.C. §119, of German patent application No. DE 10 2012 201 129.3, filed Jan. 26, 2012; the prior applications are herewith incorporated by reference in their entireties.

### BACKGROUND OF THE INVENTION

### Field of the Invention

The invention relates to a device for separating a fluid mass flow, in particular for use in a nuclear plant.

Devices of this type are usually configured as subsegments of multiple-way distributers formed as pipelines and are used in order to separate from one another liquid, gas or vapor streams (fluid mass flows) routed in pipelines and to split them into a plurality of substreams. They may also be employed correspondingly, in a reversal of the flow conditions, in order to bring together separate substreams.

In a nuclear plant, for example in a nuclear power plant, pipeline systems with distributors of this type, in particular 3-way distributors, are used in the water circuits, for example in the primary reactor cooling circuit or in the turbine circuits. Within the circuits, the pressure and temperature may attain high values or the water may be intermixed with ions or with radioactive solid particles, and therefore the pipeline systems overall, and in the pipeline systems the distributors in particular, are exposed to high stresses under which they have to be leaktight in the long term and must function with high reliability. Moreover, distributors must satisfy the requirement of separating a liquid stream into substreams having a stipulated mass flow ratio which is as constant as possible even in the case of variable pressures, temperatures and flow velocities.

Connection elements containing pipe intersections are normally used for multiple-way distributors. Thus, in particular, a crosspiece is a known form of construction used as standard for a three-way distributor. A fluid mass flow flowing in through one end piece of the crosspiece is distributed, with the flow direction remaining the same, to the remaining three end pieces, via which the separated substreams flow out. The mass ratio of the substreams is in this case set essentially by the ratios of the pipe diameters of the end pieces and by the angles between the end pieces and, furthermore, by the pressure losses in the pipelines for the three substreams.

One disadvantage is that a flow within a crosspiece generates instabilities at the edges of the pipe branches, so as to give rise in the flow, depending on the pressure and velocity distribution, to vortices and turbulences, which may lead to a time-variable mass ratio of the substreams. Although the formation of turbulences at the edges can be reduced by smoothing the pipe profiles in the region of the edges, instabilities and vortices are nevertheless formed, if only because the approximately laminar primary flow is divided in the middle part of the crosspiece. Although this effect can be reduced by angling the pipe end pieces of the crosspiece in the flow direction, it cannot be avoided entirely. Vortices and turbulences increase the friction in the flow, as compared with a flow which does not break away. The crosspiece is exposed to a high load, as compared with a straight pipe segment. The load is especially high particularly in the region of the edges of the crosspiece.

A crosspiece is usually welded together from a plurality of pipe end pieces. The weld seams therefore have to be made especially stable. Moreover, investigations are necessary at defined time intervals in order to check the state of the weld seams. This, in particular, results in increased outlay in terms of checking and maintenance when crosspieces are used as 3-way distributors.

### SUMMARY OF THE INVENTION

One object of the invention is, therefore, to specify a device by which a fluid mass flow, in particular in a nuclear plant, can be separated into substreams with a stipulated mass flow ratio, the mass flow ratio of the substreams being as constant as possible under variable pressure, temperature and velocity distributions in the fluid mass flow. Furthermore, the aim is to ensure that the substreams are as stable and free of turbulence as possible, so that the device is exposed to as low loads as possible, is therefore as reliable as possible and can be employed, with low maintenance, in a safety-critical environment, for example in a nuclear plant. A particular challenge is presented by the object of configuring the flow separation such that substreams which fluctuate or oscillate back and forth do not occur, but instead each substream independently remains stable over time.

Accordingly, a device for separating a fluid mass flow, in particular for use in a nuclear plant, is proposed, with a primary end piece for leading through the fluid mass flow and with a plurality of secondary end pieces for leading through a plurality of separate substreams of the fluid mass flow. A number of separation elements are provided in the region within the primary end piece, and each of the subregions defined by the separation element or separation elements issuing into a secondary end piece assigned specifically to the subregion.

The invention is based on the idea of geometrically separating, with the aid of separation elements, the fluid mass flow in the non-breakaway quasi-laminar region of the flow field in which there is a relatively homogeneous velocity field and there are no cross-sectional obstructions, so that the substreams arise directly in the subregions stipulated by the separation element or separation elements and from there are led further on, free of interaction, and conducted into the respective end pieces (what is known as hydraulic decoupling). In this type of separation, the flow is not disturbed in the region near the division, so that a largely homogeneous and disturbance-free division of the overall mass flow into a plurality of substreams is possible. By each substream being in each case led further on separately, there is no mutual influencing of the substreams, so that, unlike in the central region of the crosspiece, no extensive vortices and turbulences in the flow occur which would lead to increased internal friction in the flow and to time-variable mass flow ratios in the mass substreams. The mass ratios of the mass substreams are largely constant over time and depend essentially only on the size ratios of the subregions defined by the separation elements and on the overall mass flow itself.

Correspondingly, in a reversal of the flow direction, a plurality of fluid mass flows can be brought together into an overall mass flow with the aid of the device. In this case, the result of the separation element or separation elements is that the various substreams first flow together at a location where they are guided essentially parallel to one another. In a way corresponding to the case of mass flow separation, the mutual influencing of the substreams is thereby reduced, so that fewer instabilities occur in the bringing-together region in the flow field of the overall mass flow than when bringing together takes place with the aid of a crosspiece.

In a preferred embodiment of the device, the number of subregions is equal to the number of secondary end pieces. Consequently, each mass substream is assigned exactly one secondary end piece of the device, into which end piece the respective mass substream is conducted.

Advantageously, the device has a pronounced axis of symmetry. An axis of symmetry of this type is preferably identical to the central longitudinal axis of the primary end piece. Furthermore, the device with the secondary end pieces preferably has discrete symmetry with respect to rotations of the device about this axis of symmetry. This means that, when rotated about the axis of symmetry out of an initial position over an integral fraction of 360°, the device has an identical appearance to the initial position. In an especially preferred variant, the axis of symmetry lies in a plane of symmetry with respect to which the device is mirror-symmetrical.

By being shaped as symmetrically as possible, the device can be made especially compact and space-saving, this being especially important particularly for transport, installation and maintenance in a safety-critical environment, such as in a nuclear plant.

In an especially expedient development, the device is configured as a 3-way distributor. A 3-way distributor has three secondary end pieces, usually at least two of the secondary end pieces being configured essentially identically. In a specially preferred shape of a 3 way distributor, one of the secondary end pieces is formed as a continuation of the primary end piece, so that the axis of symmetry of the device and the central longitudinal axis of the primary end piece also constitute the central longitudinal axis of this secondary end piece. The other two end pieces are shaped essentially identically and are arranged opposite one another with respect to the axis of symmetry, so that the device has overall 180° rotation symmetry or mirror symmetry.

Expediently, at least one end piece is configured in the form of a guide pipe. In particular, the primary end piece and/or at least one secondary end piece may be configured in the form of a guide pipe. In an expedient development of the device, the primary end piece and the secondary end pieces are configured in the form of guide pipes which are provided in each case for a suitable connection to a matching pipeline in each case.

In the last-mentioned embodiment of the device, the or each guide pipe preferably has a smooth curvature. It follows from this, in particular, that the respective guide pipe has no flow-disturbing corners, edges and projections and/or that the guide pipe does not branch off from another pipe without continuous shape matching, in contrast to the configuration normally present in a crosspiece. At a corner or edge or, in general, at a discontinuous change in shape of the surface, flows preferentially break away and the flow field of the flow in a region around the respective corner or edge or discontinuous change of shape exhibits an unsteady behavior with breakaway/vortex formation and suffers loss. By a smooth surface curvature, such a tendency to breakaway is largely minimized, so that the flow in the pipe flows largely free of disturbance, and therefore a comparatively low load is exerted upon the pipe and low losses occur.

By contrast, for example by use of deliberate surface structuring on the inside of the or of each guide pipe, a formation of microturbulences may be perfectly desirable, since such microturbulences can suppress the formation of a characteristic boundary layer between a laminar flow field and an interface, in this case the inner face of the guide pipe, with the result that a transmission of flow forces to the pipe can be further reduced, as compared with the laminar boundary layer. However, such microturbulences are restricted essentially to the immediate boundary region of the flow with respect to the pipe inner face, so that the overall flow field of the fluid mass flow is essentially of laminar form. The deliberate generation of microturbulences to reduce dissipation forces in the boundary region between flows and interfaces by a microstructuring of the respective surface is also known as the sharkskin effect.

At least one separation element is expediently configured in the form of an inner guide pipe arranged concentrically to the primary end piece. In this case, the ratio of the mass substreams which are separated out of the overall fluid mass flow is regulated by the ratio of the cross section of the primary end piece and the cross section of the inner guide pipe with respect to a cross-sectional plane orthogonal to the axis of symmetry.

Furthermore, the inner guide pipe preferably forms a secondary end piece. Thus, in this development of the device, the separation element is configured directly as part of this secondary end piece. The substream of the fluid mass flow which is guided parallel to the axis of symmetry is thus diverted within the inner guide pipe. The other substreams of the fluid mass flow are conducted around the inner guide pipe and are in each case branched off in a suitable position from the axis of symmetry into different directions.

Expediently, at least one separation element is configured in the form of a separating fin. A separating fin of this type is an essentially planar surface segment, the surface segment being oriented essentially parallel to the main flow direction of the overall fluid mass flow. In an alternative embodiment of the device, the separating fin may be curved continuously and/or the orientation of the separating fin may have an inclination to the main flow direction of the overall fluid mass flow, so that, in a similar way to a fixed turbine blade, the flow field is continuously set increasingly in rotational movement, and so that, if the subregions defined by the separation element are shaped correspondingly, the substreams issue into the respective secondary end pieces so as to be turned with respect to the axis of symmetry of the device.

In an especially suitable embodiment of the device, the separating fin or separating fins is or are arranged between the primary end piece and the inner guide pipe. Thus, by use of a plurality of separating fins, the region between the inner wall of the primary end piece and the inner guide pipe can be divided into sectors, expediently of equal size.

In a most especially suitable embodiment of the device, the inner guide pipe, which is arranged concentrically to the primary end piece and forms a first secondary end piece, surrounds the axis of symmetry and two separating fins arranged opposite one another with respect to the axis of symmetry are provided, and the two subregions, which are semi-annular in the region of the primary end piece with respect to a cross-sectional plane orthogonal to the axis of symmetry, issue into two identical secondary end pieces arranged opposite one another with respect to the axis of symmetry.

This last-mentioned embodiment forms a 3-way distributor, the mass substreams of the overall fluid mass flow which are routed through the two identical secondary end pieces being essentially of identical size, and the size of these mass substreams being determined in each case by the product of one of the cross-sectional areas of the semi-annular subregions and the flow velocity of the fluid mass flow. The size of that substream of the fluid mass flow which is guided parallel to the axis of symmetry is determined by the product of the cross-sectional area of the inner guide pipe in the region of the primary end piece and the flow velocity of the fluid mass flow.

In an expedient development of the device, the inside diameter of the primary end piece of tubular design assumes in the region of the separating fins a value between 500 mm and 600 mm, and/or the inside diameter of the inner guide pipe assumes in the region of the primary end piece a value between 180 mm and 200 mm, and/or the inside diameter of the inner guide pipe assumes, in the end region lying opposite the region of the primary end piece, a value approximately between 180 mm and 300 mm, and/or the inside diameter of the identical secondary end pieces assumes a value between 300 mm and 400 mm.

Expedient refinements of the device relate to its design as a one-piece molding or its assembly from a plurality of moldings formed in one piece.

In a preferred refinement, the device is configured as a one-piece molding. Such a molding formed in one piece is preferably manufactured in one casting and is therefore especially robust and consequently especially low-maintenance. In particular, a molding formed in one piece has no weld seams which have to be checked especially frequently as the potentially weakest regions of a structure.

In an alternative embodiment, the device is assembled from a plurality of moldings formed in one piece. Although one-piece moldings are distinguished by an especially high degree of robustness and stability, the production of the device in one casting may be complicated and correspondingly cost-intensive if the shape is highly complex, so that it may be preferable to assemble the device from a plurality of moldings which are formed in one piece, but in each case having intrinsically a less complex shape.

In an especially preferred development of the last-mentioned design variant of the device in the form of a 3-way distributor, this is assembled from an inner guide pipe and an outer pipe branch, the inner guide pipe being led through the pipe branch through a clearance in the pipe branch, and the clearance being arranged opposite the primary end piece with respect to the axis of symmetry. Furthermore, the separating fins are preferably connected firmly to the guide pipe and/or to the pipe branch and are connected to the pipe branch or to the guide pipe, for example, in rail-shaped clearances in the pipe branch or guide pipe.

Furthermore, a screw, plug and/or bayonet connection is expediently provided for a connection of at least two of the moldings formed in one piece.

The advantages achieved by the invention are, in particular, that a fluid mass flow routed in a central pipeline is divided with little loss in the smallest possible space, by the novel distributor geometry, configured for diligent hydraulic decoupling, into three (constant) mass substreams stable over time and can be transferred into three separate pipelines. Generalizations to four-way or multiple-way distributors are possible. In manufacturing terms, welding work can be dispensed with in the production of this distributor. One possible field of use is, in particular, in boiling water reactors with an external motive water loop, in which low fluctuations in the nuclear throughput and therefore in the thermal power output can be achieved as a result of the lower time fluctuations in the distributor.

In a linguistically alternative characterization, the invention relates to a device, also designated as a pipe branch or as a 3- (or multiple-) way distributor, for separating a primary fluid mass flow or, in brief, fluid flow into at least three secondary substreams separated from one another:

a) with a primary end piece in the form of an essentially straight pipe/pipe section, which, as seen in the flow direction of the primary fluid flow, branches into at least two pipe bends which preferably confront one another on the outlet side and merge in each case into secondary end pieces,
b) with an essentially straight separation pipe (also designated further above as the inner guide pipe), which is led through the branch formed by the pipe bends and has an inner portion which projects in the manner of a nested arrangement into the primary end piece, so as to form an annular gap, and which, as seen in the flow direction, merges into an outer portion, which forms a further secondary end piece,
c) so that, as seen in the cross section of the primary end piece, a central fraction of the primary fluid flow flows into the separation pipe and flows through this essentially without any deflection in direction and so that the remaining outer fraction, assigned to the annular cross section of the annular gap, of the primary fluid flow is distributed through the annular gap to the at least two pipe bends.

In this case, the separation pipe is preferably arranged concentrically to the primary end piece and engages by its inner portion, open at the end, into the primary end piece.

Furthermore, advantageously, there are a number of separating fins for separating the substreams entering the pipe bends from one another, which separating fins are arranged in the annular gap, project radially from the separation pipe and extend in the longitudinal direction of the latter. In the case of two pipe bends pointing in opposite directions on the outlet side, two such separating fins are present, preferably at circumferential points of the separation pipe which lie opposite one another.

Moreover, it is advantageous if the pipe bends are arranged in the manner of an equal division of a full circle, as seen in the circumferential direction of the primary end piece. In the case of two pipe bends, the axes of the secondary end pieces adjoining these preferably lie generally in one plane.

Advantageously, each of the pipe bends possesses a curvature angle in the range of 30° to 120°, preferably approximately 90°.

Finally, it is expedient if the separation pipe is sealed off in the region of passage/penetration through the branch with respect to the pipe walls surrounding the pipe bends. That is to say, the margin of the corresponding clearance in the pipe walls bears, preferably free of gaps, against the separation pipe.

Since the last-mentioned linguistically alternative characterization refers to the same invention which was characterized previously in another way, the corresponding portions of the text can be combined with one another in any way, if appropriate with the nomenclature being adapted.

Other features which are considered as characteristic for the invention are set forth in the appended claims.

Although the invention is illustrated and described herein as embodied in a device for separation a fluid mass flow, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a device for separating a fluid mass flow according to the invention;

FIG. 2 is a front view of the device according to FIG. 1;

FIG. 3 is a diagrammatic, perspective view, once again, of the device according to FIG. 1, with exemplary geometric characteristic quantities;

FIG. 4 is an exploded view of the device and makes clear a set-up of the device according to FIG. 1; and

FIG. 5 is a diagrammatic, perspective view of the device according to FIG. 1, but with additional reference symbols.

### DETAILED DESCRIPTION OF THE INVENTION

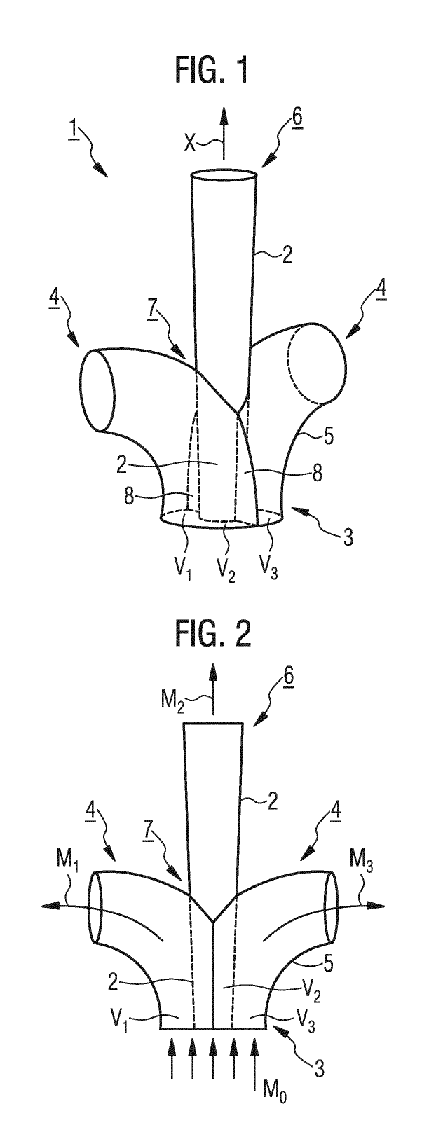

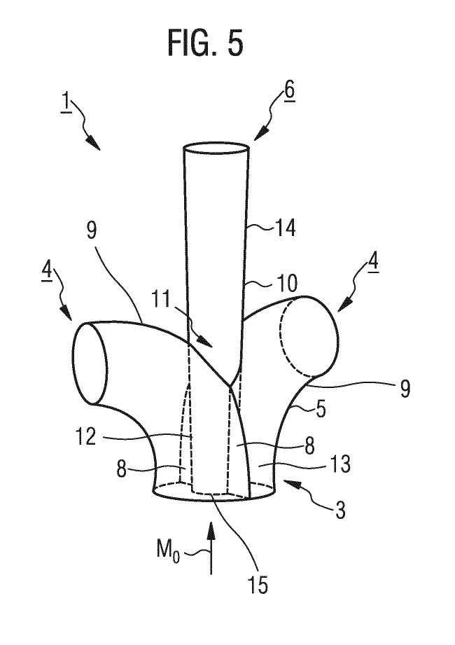

Identical parts in FIG. 1 to FIG. 4 are given the same reference symbols. These reference symbols are also used in FIG. 5, in which, however, additional reference symbols are also used in view of an alternative linguistic characterization of the invention. Referring now to the figures of the drawings in detail and first, particularly to FIG. 1 thereof, there is shown a device 1, also designated as a distributor, for separating a fluid mass flow Mo. The device 1 contains a conically tapered inner guide pipe 2, which is concentrically surrounded at the narrower end by a tubular primary end piece 3. The primary end piece 3 is connected to two identically shaped secondary end pieces 4 arranged opposite one another with respect to the inner guide pipe 2, so that the primary end piece 3 together with the two secondary end pieces 4 form a pipe branch 5. In the wider end region of the inner guide pipe 2, which region is arranged opposite the primary end piece 3 with respect to an axis of symmetry X, the inner guide pipe forms a further secondary end piece 6. In this case, the inner guide pipe 2 is led out of the pipe branch 5 through an orifice 7 having an exact fit and closing off sealingly at the periphery.

The axis of symmetry X of the device 1 corresponds to the longitudinal axis of the inner guide pipe 2 and to the longitudinal axis of the primary end piece 3. On account of the arrangement of the two identically shaped secondary end pieces 4, in the exemplary embodiment the device 1 is symmetrical with respect to rotation through 180° about the axis of symmetry X. The two identically shaped secondary end pieces 4 may alternatively have central axes inclined slightly in relation to one another, but do not therefore necessarily have to point in exactly opposite directions, as seen in the circumferential direction of the primary end piece 3.

Between the inner guide pipe 2 and the primary end piece 3, two separating fins 8 are formed, lying opposite one another with respect to the axis of symmetry X, each separating fin 8 forming an essentially right angle with each of the identically shaped secondary end pieces 4 with respect to a cross-sectional plane orthogonal to the axis of symmetry X. The surface area of the inner guide pipe 2 in the region of the primary end piece 3 and the two separating fins 8 define three subregions V1, V2, V3 within the primary end piece 3, the first subregion V1 being of a generally semiannular form, as seen in cross section, and surrounding the inner guide pipe 2 concentrically on one half side, the second subregion V2 constituting the cylindrical inner volume of the inner guide pipe, and the third subregion V3 corresponding to the shape of the first subregion V1 and being arranged opposite the first subregion V1. Each subregion V1, V2, V3 issues respectively into one of the secondary end pieces 4, 6, 4.

The inner guide pipe 2 has a continuously increasing diameter from one end face in the region of the primary end piece 3 toward the other end side of the secondary end piece 6 and consequently assumes a slightly conical shape. The pipe branch 5 has, in the region of the transition from the primary end piece 3 to the secondary end pieces 4, an essentially uniformly curved profile and therefore, in particular, possesses no flow-breaking edges.

FIG. 2 shows the device 1 according to FIG. 1 in a lateral projection. In this illustration, the fluid mass flow Mo flowing into the device 1 in the region of the primary end piece 3 is identified symbolically by arrows. The fluid mass flow Mo is separated geometrically by the inner guide pipe 2 and by the separating fins 8 and distributed to the three subregions V1, V2, V3 within the primary end piece 3 (in the view chosen here, the separating fins 8 stand perpendicularly on the viewing plane, only one separating fin 8 being illustrated visibly as a vertical line).

The mass substreams M1, M2, M3 formed in the subregions V1, V2, V3 are diverted in separate directions in each case to a secondary end piece: the mass substream M2 is discharged through the inner guide pipe 2 in parallel with the axis of symmetry X and is thus delivered to the secondary end piece 6; the other two mass substreams M1, M3 are diverted within the pipe branch 5 around the inner guide pipe 2 and via the secondary end pieces 4. As a result of the geometric separation of the fluid mass flow Mo in the region of the primary end piece 3, the flow field of the mass substreams, M1, M2, M3 remains intact essentially without breakaway zones.

All further details may be gathered from the description of FIG. 1.

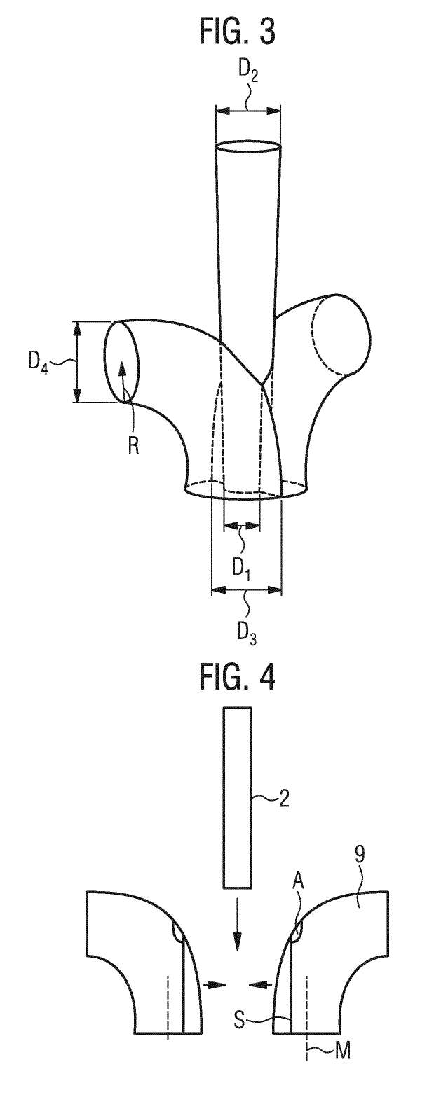

According to the various conceivable intended uses, the geometric parameters of the device 1 may vary greatly. In the variant illustrated in FIG. 3, intended for use in the cooling liquid circuit of a boiling water reactor, a diameter D1 of the narrow end of the inner guide pipe 2 amounts, for example, to about 190 mm and a diameter D2 of the outer wide end of the guide pipe 2 amounts to about 290 mm. The diameter D3 of the primary end piece 3 amounts to about 530 mm, and the diameter D4 of the two secondary end pieces 4 in the region of their outlet orifices amounts in each case to about 350 mm. A radius of curvature R of the two pipe bends extending between the primary end piece 3 and the respective secondary end piece 4 amounts to about 600 mm.

It can be gathered from FIG. 4 that, theoretically and/or actually, the device 1 can be set up as follows: two preferably identical pipe bends 9 are in each case cut into, parallel to a mid-axis M, through one of their end orifices along the cutting edge S. Furthermore, a suitable clearance A for the guide pipe 2 is introduced into the remaining part of the respective pipe bend 9. The remaining parts of the pipe bends 9 are subsequently brought together in the way shown by directional arrows and are connected to one another/joined together at the cutting edges S. Moreover, the guide pipe 2 is introduced into the clearance A and is fixed there in the final position. Finally, the separating fins, not illustrated here, which are contoured with an exact fit, are also inserted into the composite structure and fixed. The connecting points between the pipe bends 9, guide pipe 2 and separating fins are sealed off, free of gaps, in relation to one another.

Modifications of the basic shape illustrated can, of course, also be implemented. Thus, for example, a corresponding 4-way distributor could be formed, with a straight inner guide pipe and with three outwardly bent pipe bends which emanate from one common primary end piece (inlet orifice) and which will in each case have to be arranged at an angular spacing of 120° with respect to one another, preferably in the manner of an equal division of the 360° full angle. Three separating fins would have to be provided in this case. Moreover, the inner guide pipe does not necessarily have to be configured conically. It could, instead, have a constant inner cross section. Alternatively, in the case of a conical configuration, the wide end could be arranged within the primary end piece and the narrow end could project outward from the pipe branch.

The drawing in FIG. 5 is identical to the drawing in FIG. 1. The inner guide pipe 2 from FIG. 1 has been designated alternatively in FIG. 5 as a separation pipe 10. In addition, an annular gap 13 between an inner portion 12 of the separation pipe 10 and the primary end piece 3 branching off to the two pipe bends 9 in a branch 11 has been indicated there. That portion of the separation pipe 10 which emerges from the branch 11 at the top has been labeled as an outer portion 14. At its lower end, projecting into the primary end piece 3, the separation pipe 10 possesses an inlet orifice 15. The pipe section forming the primary end piece 3 will generally, contrary to the drawing, extend even further downward and project in the axial direction beyond the periphery of the inlet orifice 15 of the separation pipe 10. The secondary end pieces 4 and 6 may, of course, likewise be drawn even further outward. The separating fins 8 may, contrary to the drawing, project downward beyond the periphery of the inlet orifice 15 or, alternatively, have a lower edge arranged further above, so that, in the latter case, the separation pipe 10 projects downward beyond the separating fins 8. In general, pipelines, not illustrated here, which lead further on may be connected to or integrally formed on the end pieces 3, 4 and 6.

1. A device for separating a fluid mass flow, the device comprising:
a primary end piece for leading through the fluid mass flow;
a plurality of secondary end pieces for leading through a plurality of separate substreams of the fluid mass flow; and
a number of separation elements disposed in a region within said primary end piece and defining subregions, each of said subregions defined by said separation elements issuing into one of said secondary end pieces assigned specifically to a subregion of said subregions.

2. The device according to claim 1, wherein a number of said subregions being equal to a number of said secondary end pieces.

3. The device according to claim 1, wherein the device has an axis of symmetry.

4. The device according to claim 1, wherein the device is a 3-way distributor with three said secondary end pieces.

5. The device according to claim 1, wherein at least one of said secondary end pieces is a guide pipe.

6. The device according to claim 5, wherein said guide pipe has a smooth curvature.

7. The device according to claim 1, wherein at least one of said separation elements is an inner guide pipe disposed concentrically to said primary end piece.

8. The device according to claim 7, wherein said inner guide pipe forms one of said secondary end pieces.

9. The device according to claim 8, wherein at least a respective one of said separation elements is a separating fin.

10. The device according to claim 9, wherein said respective separating fin is disposed between said primary end piece and said inner guide pipe.

11. The device according to claim 10, wherein:
said inner guide pipe disposed concentrically to said primary end piece and forms one of said secondary end pieces, surrounds an axis of symmetry; and
two of said separating fins are disposed opposite one another with respect to the axis of symmetry.

12. The device according to claim 11, wherein two of said subregions are semi annularly shaped in a region of said primary end piece with respect to a cross-sectional plane orthogonal to the axis of symmetry and issue into two identical said secondary end pieces disposed opposite one another with respect to the axis of symmetry.

13. The device according to claim 12, wherein at least one of:
said primary end piece is of a tubular design and has an inside diameter in a region of said separating fins with a value between 500 mm and 600 mm;
said inner guide pipe having an inside diameter in a region of said primary end piece with a value between 180 mm and 200 mm;
said inner guide pipe, in an end region lying opposite said region of said primary end piece, has an inside diameter with a value between 180 mm and 300 mm; or
said two identical said secondary end pieces having an inside diameter of a value between 300 mm and 400 mm.

14. The device according to claim 1, wherein the device is a one-piece molding produced by casting and is for use in a nuclear plant.

15. A device for separating a primary fluid flow into at least three secondary substreams separated from one another, the device comprising:
secondary end pieces;
a primary end piece in a form of a pipe section which, as seen in a flow direction of the primary fluid flow, branches into at least two pipe bends which merge in each case into said secondary end pieces;
an outer portion forming a further secondary end piece; and
a generally straight separation pipe being led through a branch formed by said pipe bends and having an inner portion projecting in a manner of a nested configuration into said primary end piece, so as to form an annular gap, and which, as seen in the flow direction, merges into said further secondary end piece, so that, as seen in a cross section of said primary end piece, a central fraction of the primary fluid flow flows as one of the secondary substreams through said separation pipe generally without deflection in direction, and so that a remaining outer fraction of the primary fluid flow is distributed through said annular gap to said at least two pipe bends, so as to form further ones of the secondary substreams.

16. The device according to claim 15, wherein said separation pipe is disposed concentrically to said primary end piece.

17. The device according to claim 15, further comprising separating fins for separating the secondary substreams entering said pipe bends from one another, said separating fins are disposed in said annular gap, project radially from said separation pipe and extend in a longitudinal direction of said separation pipe.

18. The device according to claim 15, wherein said pipe bends disposed in a manner of an equal division of a full circle, as seen in the circumferential direction of said primary end piece.

19. The device according to claim 15, wherein each of said pipe bends possessing a curvature angle in the range of 30° to 120°.

20. The device according to claim 15, wherein said separation pipe is sealed off in a region of passage through said branch with respect to pipe walls surrounding said pipe bends.

21. The device according to claim 15, wherein each of said pipe bends possessing a curvature angle of approximately 90°.
